(19) United States
(12) Patent Application Publication
(10) Pub. No.: US 2011/0169936 A1
(43) Pub. Date: Jul. 14, 2011

(54) MICROSCOPE

(75) Inventor: Hiroshi NAIKI, Tokyo (JP)

(73) Assignee: OLYMPUS CORPORATION, Tokyo (JP)

(21) Appl. No.: 12/973,404

(22) Filed: Dec. 20, 2010

(30) Foreign Application Priority Data
Jan. 14, 2010 (JP) 2010-005873
Jan. 14, 2010 (JP) 2010-005877

(51) Int. Cl. H04N 7/18; G02B 21/26

(52) U.S. Cl. 348/79; 359/394; 348/E07.085

(57) ABSTRACT

A microscope comprising: an XY stage unit for moving a sample holding unit for holding a sample in an optional XY direction within an XY plane orthogonal to the optical axis of an image forming optical system; a display unit for displaying a sample image photographed by a photographing device for photographing a sample image formed by the image forming optical system; a rotating unit for rotating the sample holding unit around an axis perpendicular to the XY plane; and a control unit for controlling the XY stage unit and the rotating unit so that the sample image displayed on the display unit is rotated within a screen.

### CROSS REFERENCE TO RELATED APPLICATIONS

This application is based upon and claims the benefit of priority from the prior Japanese Patent Application Nos. 2010-5873 and 2010-5877, filed Jan. 14, 2010, the entire contents of which are incorporated herein by reference.

### BACKGROUND OF THE INVENTION

1. Field of the Invention

The present invention relates to a microscope with an image shooting device for observing a sample, and particularly relates to a microscope comprising a rotation mechanism with which a shot sample image can be rotated at an optional angle to be observed.

2. Description of the Related Art

Conventionally, microscopes with which a minute sample can be enlarged and observed and also shot and recorded as a picture or a video image have been widely used in research, inspection, and the like in industry as well as in biology. In such fields, the need for microscopes to be able to be used in a simpler fashion is increasing; accordingly, many pieces of control software have been developed to satisfy this need.

As an example, as described in Japanese Laid-open Patent Publication No. 5-40230, a technology has been disclosed in which, in order to simplify a framing operation during a micro-observation, a framing frame for the micro-observation is displayed on a macro image; a micro-observation magnification is designated by viewing the size of the frame as a screen size for the micro-observation so as to designate the size of the frame; and the stage position for the micro observation is designated by viewing the center position of the frame as the center of the screen for the micro-observation so as to designate the position of the frame.

In addition, when the image of a sample with directionality is shot, a plurality of shooting results of the sample are visually compared with one another; therefore, it is requested that the sample image be rotated and displayed. Accordingly, a hardware mechanism typically enabling a camera or a sample (or a holder for holding the sample) to be rotated on a plane perpendicular to the image-shooting optical axis is conventionally provided.

### SUMMARY OF THE INVENTION

A microscope according to the present invention comprises: a sample holding unit for holding a sample; an image forming optical system for forming an image of the sample via an objective lens and an image forming lens; an XY stage unit for moving the sample holding unit in an optional XY direction within an XY plane orthogonal to the optical axis of the image forming optical system; a photographing device for photographing a sample image formed by the image forming optical system; a display unit for displaying the sample image photographed by the photographing device; a rotating unit for rotating the sample holding unit around the axis perpendicular to the XY plane; and a control unit for controlling the XY stage unit and the rotating unit so that the sample image displayed on the display unit is rotated within the screen.

### BRIEF DESCRIPTION OF THE DRAWINGS

The present invention will be more apparent from the following detailed description when the accompanying drawings are referenced.

FIG. 1 is a diagram showing a schematic of a microscope to which the present invention is applied.

FIG. 2 is a diagram showing functions of a microscope according to a first embodiment.

FIG. 3 is a flowchart indicating the flow of a first rotation control process program executed by a control unit 102.

FIG. 4 is a diagram showing an example of GUIs displayed on a display unit 109.

FIG. 5 is a diagram illustrating an example of corrections.

FIG. 6 is a diagram showing functions of a microscope according to a second embodiment.

FIG. 7 is a diagram showing a schematic of a microscope to which the present invention is applied.

FIG. 8 is a diagram showing functions of a microscope according to a third embodiment.

FIG. 9 is a flowchart indicating the flow of a second rotation control process program executed by the control unit 102.

FIG. 10 is a diagram illustrating an example of corrections.

FIG. 11 is a diagram showing functions of a microscope according to a fourth embodiment.

FIG. 12 is a diagram showing functions of a microscope according to a fifth embodiment.

FIG. 13 is a diagram showing functions of a microscope according to a sixth embodiment.

FIG. 14 is a diagram indicating a method for setting a rotation angle via a drag-and-drop operation on a live image.

FIG. 15 is a diagram indicating a method for setting a rotation angle via a drag-and-drop operation for which a linear mark serving as an indicator is used.

### DESCRIPTION OF THE PREFERRED EMBODIMENTS

In the following, first to seventh embodiments of the present invention will be described in detail with reference to the drawings.

### First Embodiment

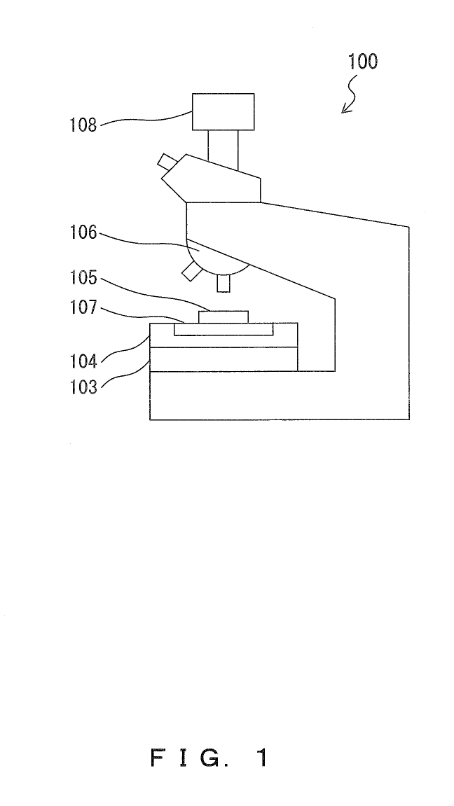

FIG. 1 is a diagram showing a schematic of a microscope to which the present invention is applied.

In regard to FIG. 1, a microscope 100 comprises an XY stage unit 103, a holder unit 104 serving as a sample holding unit, an image forming optical system 106, a rotating unit 107, and a camera unit 108 serving as a photographing device, and can photograph a sample 105.

The image forming optical system 106 irradiates light onto the sample 105, which is an observation object, receives light from the sample 105 via an objective lens and an image forming lens, and forms an image of the sample 105. The camera unit 108 is, for example, a CCD camera or the like, and photographs a sample image formed by the image forming optical system 106.

The holder unit 104 holds the sample 105. The XY stage unit 103 moves the holder unit 104 in an optional X direction or Y direction within an XY plane orthogonal to the optical axis of the image forming optical system 106. Here, the X direction and Y direction are orthogonal to each other.

The rotating unit 107 rotates the holder unit 104 around an axis that is perpendicular to the XY plane orthogonal to the optical axis of the image forming optical system 106. This means that the rotation axis of the rotating unit 107 is parallel to the optical axis of the image forming optical system 106.

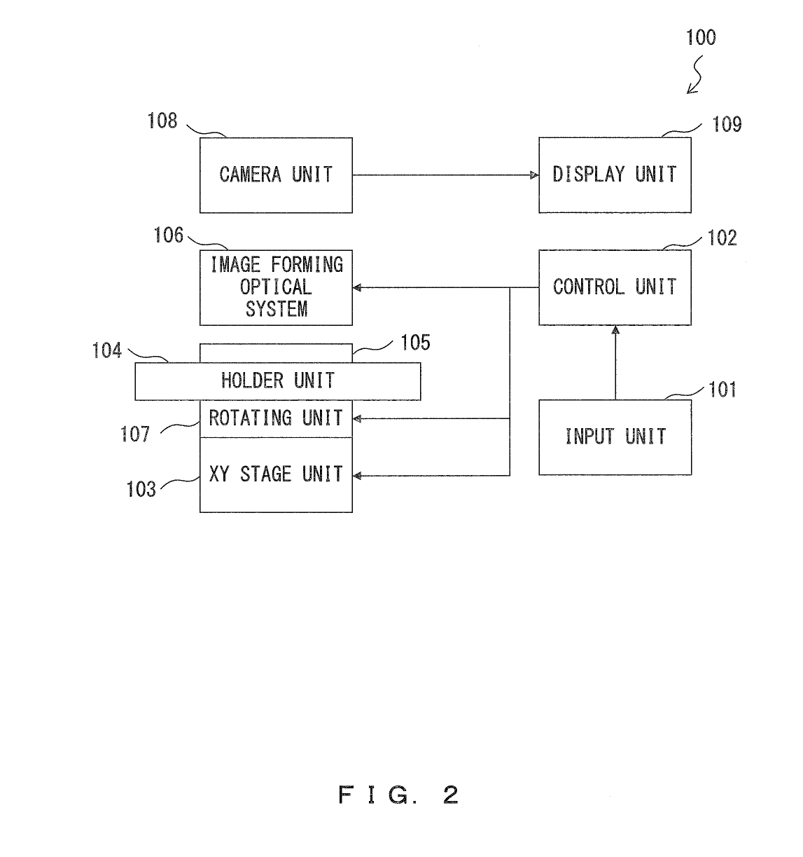

FIG. 2 is a diagram showing functions of a microscope according to the first embodiment.

In FIG. 2, the microscope 100 also comprises the components described using FIG. 1 and further comprises an input unit 101, a control unit 102, and a display unit 109.

The input unit 101 inputs various pieces of data, information, or instructions to the microscope 100. The control unit 102 is connected to the input unit 101, and, on the basis of information or instructions input via the input unit 101, it controls each part of the microscope 100 and the entirety of the microscope 100.

The display unit 109 is, for example, a liquid crystal display device, and displays the sample image photographed by the camera unit 108. When an instruction is given to rotate, within the screen, the sample image displayed on the display unit 109, the control unit 102 controls the XY stage unit 103 and the rotating unit 107 by executing the first rotation control process program, which will be described later.

Such an instruction is given using the input unit 101. As an example, via the input unit 101, it is possible to input a rotation angle of the sample image within the screen of the display unit 109. When a rotation angle of the sample image within the screen of the display unit 109 is input via the input unit 101, the control unit 102 calculates a movement amount of the holder unit 104 to be moved by the XY stage unit 103 on the basis of the input rotation angle and the relative position relationship between the center of the display coordinate axis, which is the center of the display unit 109, and the center of the stage coordinate axis, which is the center of the XY stage unit 103. Then, the control unit 102 moves the XY stage unit 103 in accordance with the calculated movement amount.

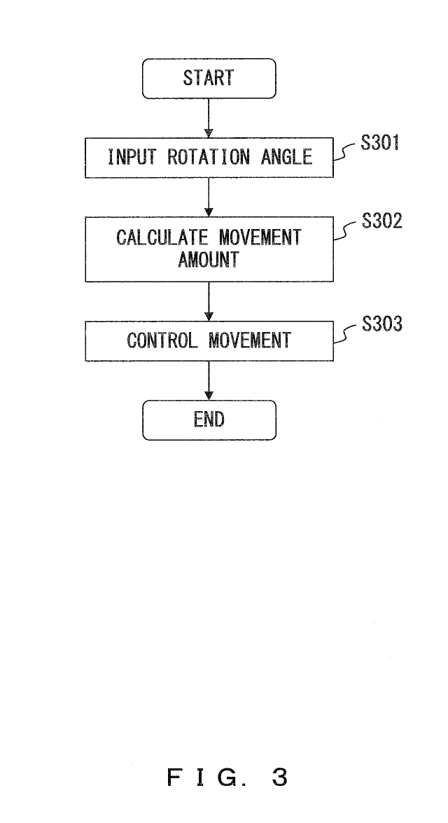

FIG. 3 is a flowchart indicating the flow of the first rotation control process program executed by the control unit 102.

First in step S301, a rotation angle is input via, for example, an operator designating or inputting angle data using an edit box displayed on the display unit 109.

Next, in step S302, a movement amount of the holder unit 104 to be moved by the XY stage unit 103 is calculated on the basis of the input rotation angle and the relative position relationship between the center of the display coordinate axis, which is the center of the display unit 109, and the center of the stage coordinate axis, which is the center of the XY stage unit 103. Specifically, when an image is rotated around the center point of the stage coordinate axis, the rotation angle is used to calculate the center point of the display coordinate axis after the rotation from the center point of the display coordinate axis before the rotation.

Then, in step S303, the XY stage unit 103 is moved in accordance with the calculated movement amount. Specifically, the XY stage unit 103 is moved so that the center point of the display coordinate axis before the rotation is identical with the calculated center point of the display coordinate axis after the rotation.

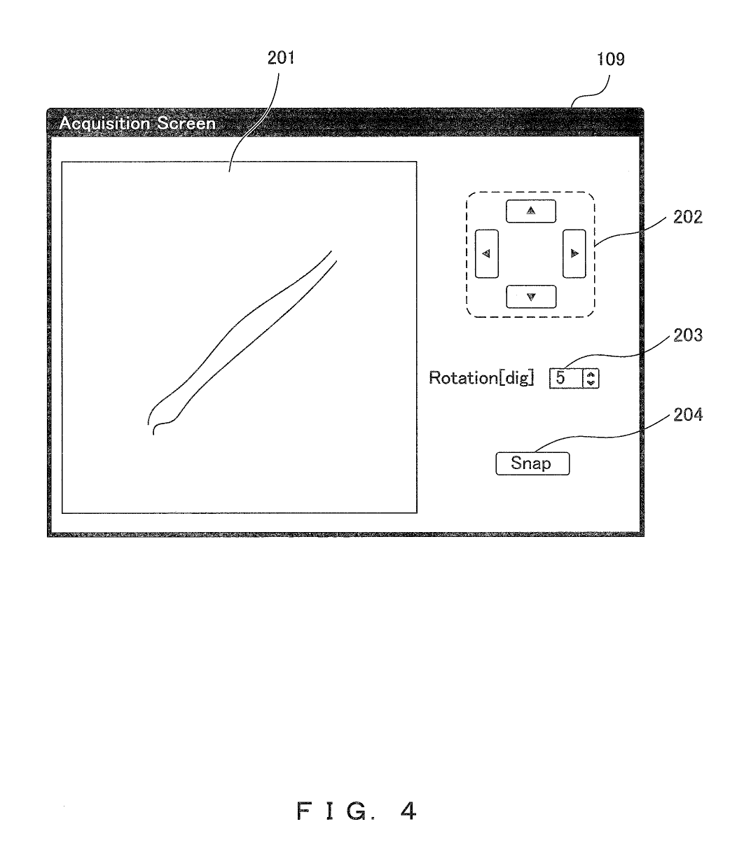

FIG. 4 is a diagram showing an example of GUIs displayed on a display unit 109.

In FIG. 4, the display unit 109 is configured with a live display unit 201, an XY movement instruction unit 202, a rotation instruction unit 203, and a photographing instruction unit 204.

The live display unit 201 displays a live image of the sample 105. The XY movement instruction unit 202 inputs an instruction to move the sample 109 in the vertical direction or horizontal direction relative to the live display unit 201. Via an operator's operation, the rotation instruction unit 203 inputs an instruction to rotate a sample image around the center of the live display unit 201. In the example shown in FIG. 4, the image is rotated by five degrees. The photographing instruction unit 204 gives an instruction to perform photographing via the camera unit 108.

Assume that a live image of the sample 105 as shown in FIG. 4 is currently displayed on the image display unit 201. In this case, via the movement of the XY stage unit 103, the position relationship between the rotation center of the rotating unit 107 and the center of the visual field of the camera unit 108 changes. Therefore, in order for the same observation point as that before the rotation to be displayed on the display unit 109 after the rotation, it is necessary to correct the position of the XY stage unit 103 on the basis of the position relationship above. As an example, this correction is performed as follows.

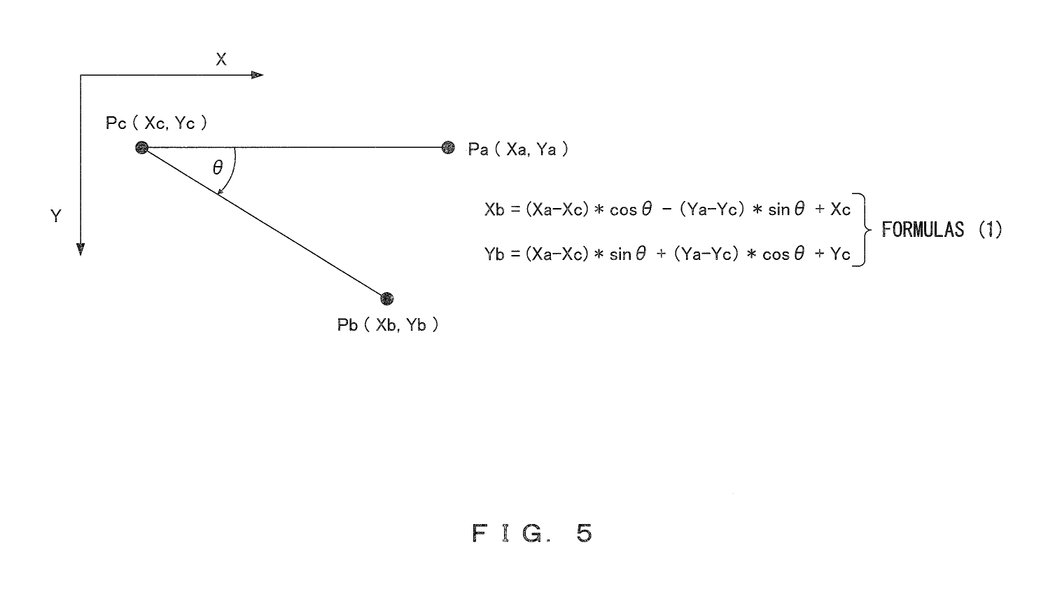

FIG. 5 is a diagram illustrating an example of the correction.

Assume that as shown in FIG. 5, θ indicates the rotation angle, Xa indicates the X coordinate of a pre-movement position Pa of the sample 105 that was displayed at the center of the visual field of observation before rotation, Ya indicates the Y coordinate of the pre-movement position Pa, Xc indicates the X coordinate of a rotation center Pc of the rotating unit 107, and Yc indicates the Y coordinate of the rotation center Pc. Accordingly, the X coordinate Xb and the Y coordinate Yb of a post-movement position Pb, at which the sample 105 moved from the pre-movement position Pa is located after the rotation, are expressed using the following formulas (1).

Xb=(Xa−Xc)×cosθ−(Ya−Yc)×sinθ+Xc,

Yb=(Xa−Xc)×sinθ−(Ya−Yc)×cosθ+Yc, (1)

Therefore, when an instruction to rotate a live image by θ degrees is given, Xb and Yb are calculated in accordance with the formulas (1) above and the XY stage unit 103 is moved in accordance with the rotation; accordingly, after the rotation, the same observation point as that before the rotation can be kept at the center of the screen.

As an example, when θ=90°, Xa=100, Ya=10, Xc=10 and Yc=10, the XY stage unit 103 after the rotation will be positioned at the following coordinates.

Xb=(100−10)×cos90°−(10−10)×sin90°+10=10,

Yb=(100−10)×sin90°+(10−10)×cos90°+10=100,

As described above, according to the first embodiment, even in a structure in which a rotation center is not identical with the center of a visual field, the observation point won't be invisible due to the rotation since the same observation point as that before the rotation is kept at the center of the screen after the rotation.

### Second Embodiment

Next, a second embodiment to which the present invention is applied will be described.

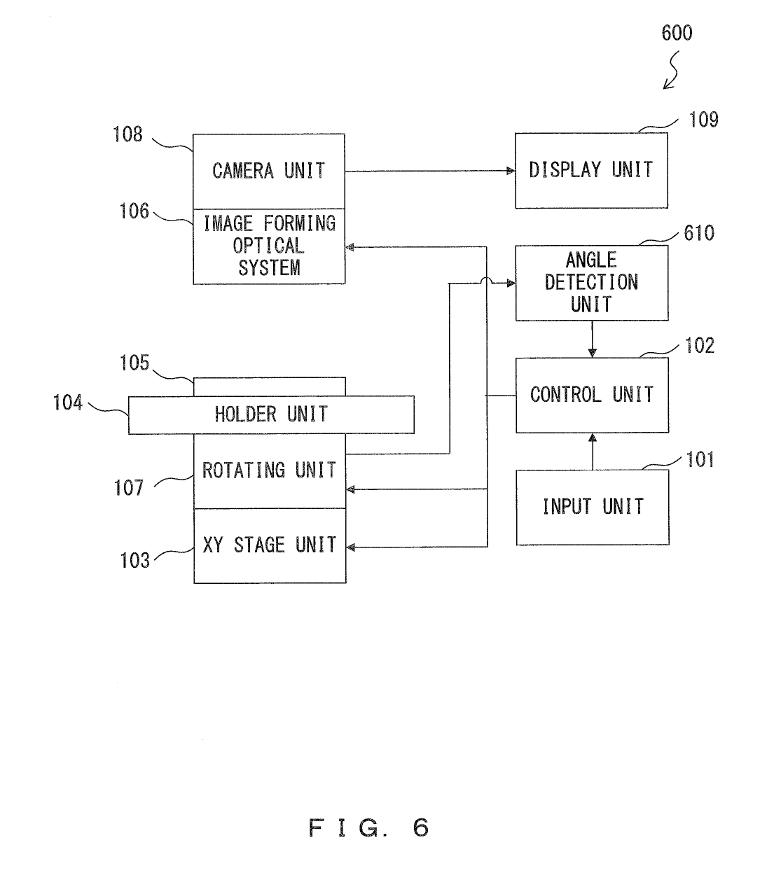

FIG. 6 is a diagram showing functions of a microscope according to the second embodiment.

In FIG. 6, the microscope 600 comprises an angle detection unit 610 in addition to the components provided for the microscope 100 according to the first embodiment that was described using FIGS. 1 and 2.

In the first embodiment described above, a rotation angle, designated via an operator operating the rotation instruction unit 203, is input by the input unit 101. In the second embodiment, when the rotating unit 107 is rotated via a mechanical operation manually provided by an operator or via an electronic operation so as to rotate the holder unit 104, the angle detection unit 610 can also detect the rotation angle.

As an example, in FIG. 6, the angle detection unit 610 connected to the rotating unit 107 can detect an angle using hardware, such as a rotary encoder, and can detect an angle by calculating the movement direction from the image before the movement of the XY stage unit 103 and the image after the movement of the XY stage 103. As a result of this, when the operator gives an instruction, via a manual operation, to rotate the holder unit 104 via the rotating unit 107, the rotation angle (rotation amount) can also be grasped immediately and the XY stage unit 103 can be operated in accordance with the rotation.

### Third Embodiment

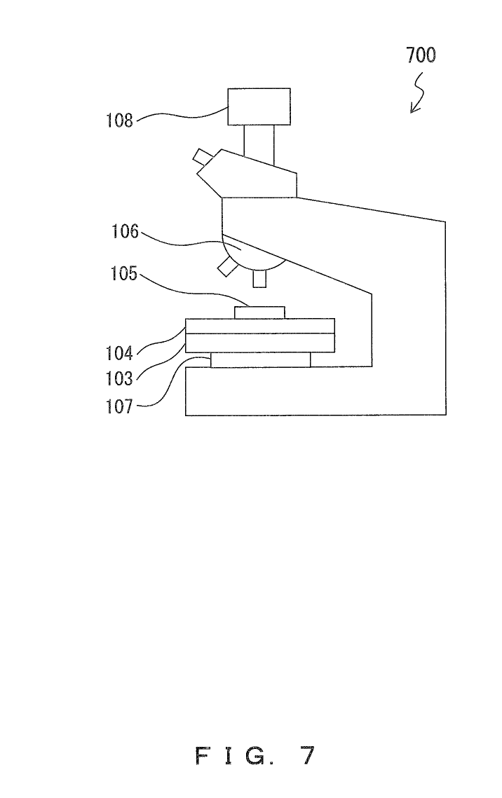

FIG. 7 is a diagram showing a schematic of a microscope to which the present invention is applied.

In FIG. 7, the microscope 700 comprises the XY stage unit 103, the holder unit 104, the image forming optical system 106, and the camera unit 108, which are comprised by the microscope 100 shown in FIG. 1. The microscope 700 also comprises a rotating unit 707 instead of the rotating unit 107, and can photograph the sample 105.

The rotating unit 707 rotates the XY stage unit 103 around an axis that is vertical to the XY plane orthogonal to the optical axis of the image forming optical system 106.

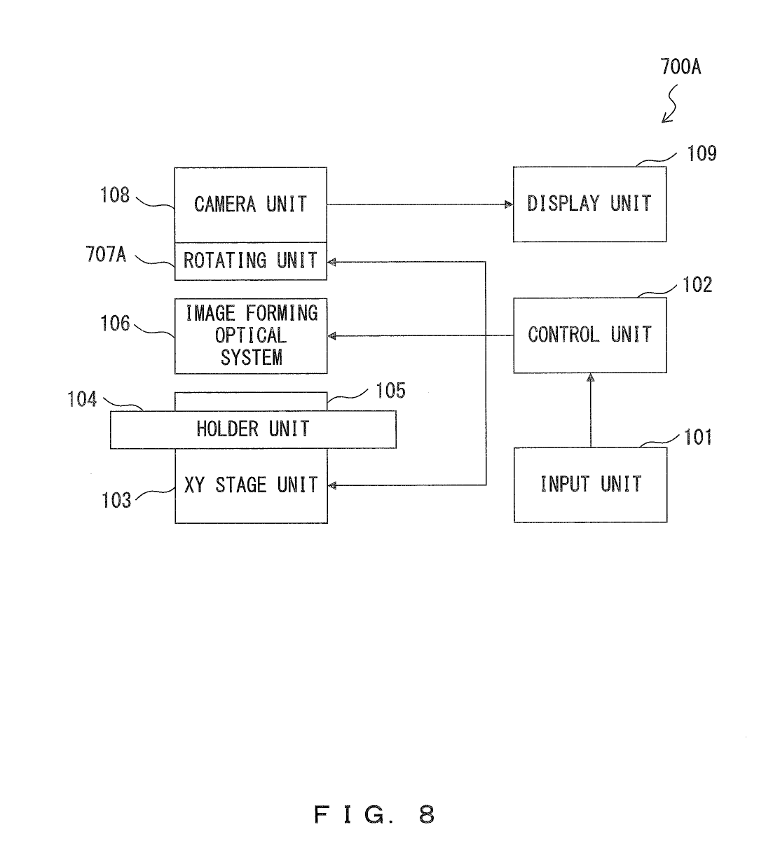

FIG. 8 is a diagram showing functions of a microscope according to the third embodiment.

In FIG. 8, in addition to the components comprised by the microscope 700 described using FIG. 7, a microscope 700A comprises the input unit 101, the control unit 102, and the display unit 109. Instead of the rotating unit 707 comprised by the microscope 700, the microscope 700A comprises a rotating unit 707A that rotates the camera unit 108 around the optical axis of the image forming optical system 106.

The input unit 101 inputs various pieces of data, information, or instructions to the microscope 700A. The control unit 102 is connected to the input unit 101, and, on the basis of information or instructions input via the input unit 101, it controls each part of the microscope 700A and the entirety of the microscope 700A.

The display unit 109 is, for example, a liquid crystal display device, and displays the sample image photographed by the camera unit 108. When an instruction is given to rotate, within the screen, the sample image displayed on the display unit 109, the control unit 102 controls the XY stage unit 103 and the rotating unit 707A. After the rotation, when a region displayed on the display unit 109 is moved, the control unit 102 controls the XY stage unit 103 by executing a second rotation control process program, which will be described later.

As with the case in the first embodiment that was described using FIG. 2, an instruction in such a situation is given by using the input unit 101 so as to input a rotation angle by which the sample image rotates within the screen of the display unit 109. When a rotation angle of the sample image within the screen of the display unit 109 is input via the input unit 101, the control unit 102 calculates a movement direction of the holder unit 104 to be moved by the XY stage unit 103 on the basis of the input rotation angle and the amount of movement within the display unit 109. Then, the control unit 102 moves the XY stage unit 103 in accordance with the calculated movement direction.

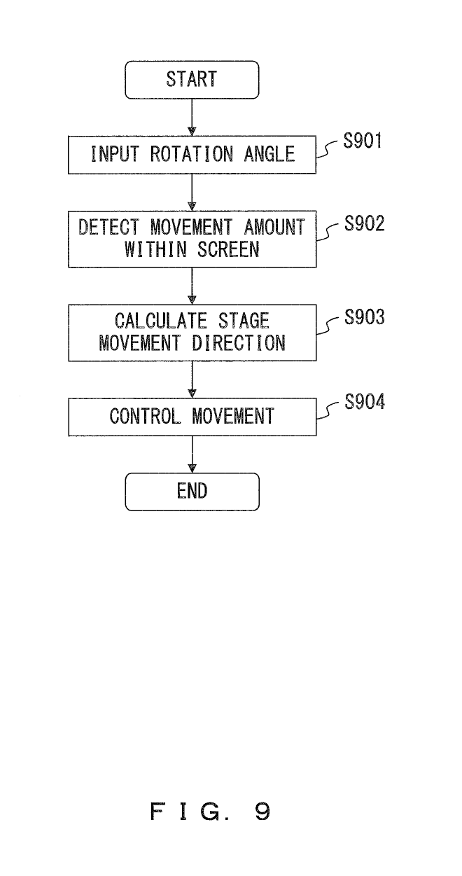

FIG. 9 is a flowchart indicating the flow of the second rotation control process program executed by the control unit 102.

First, in step S901, a rotation angle is input via, for example, an operator designating or inputting angle data using the edit box displayed on the display unit 109. In accordance with this input rotation angle, the rotating unit 707A rotates the camera unit 108.

Next, when a region displayed on the display unit 109 after the rotation is moved, the movement amount will be detected in step S902. Then, in step S903, on the basis of the input rotation angle and the amount of movement within the display unit 109, the movement direction of the holder unit 104 to be moved by the XY stage unit 103 is calculated. Specifically, the positions before and after the movement within the display unit 109 are converted from a display-coordinate-axis base to a stage-coordinate-axis base.

Then, in step S904, the XY stage unit 103 is moved in accordance with the calculated movement direction.

Assume that a live image of the sample 105 is currently displayed on the image display unit 201 as shown in FIG. 4 described above. In this case, when the operator gives an instruction to move the XY stage unit 103, the position of the XY stage 103 needs to be adequately corrected in light of the rotation amount of the camera unit 108 in order to move the observation point in the direction corresponding to the instruction. As an example, such a correction can be performed as follows.

First, assume that an operator gives, via the rotation instruction unit 203, an instruction to perform a θ degree rotation. Then, this instruction is passed via the input unit 101 and the control unit 102 to the rotating unit 707A, thereby causing the rotating unit 707A to rotate the camera unit 108 by θ degrees. As a result of this, the live image, rotated by θ degrees around the center of the live display unit 201, is displayed. For purposes of illustration, assume that the angle θ is 0 degrees when the measurement-point movement direction of the XY stage unit 103 is identical with the measurement-point movement direction on the image.

Next, assume that the operator gives an instruction to move the XY stage unit 103. In this case, in order to move the observation point in the direction indicated by the live display unit 201, the movement-destination coordinate needs to be converted in accordance with a rotation angle at that time. Such a conversion is performed as follows.

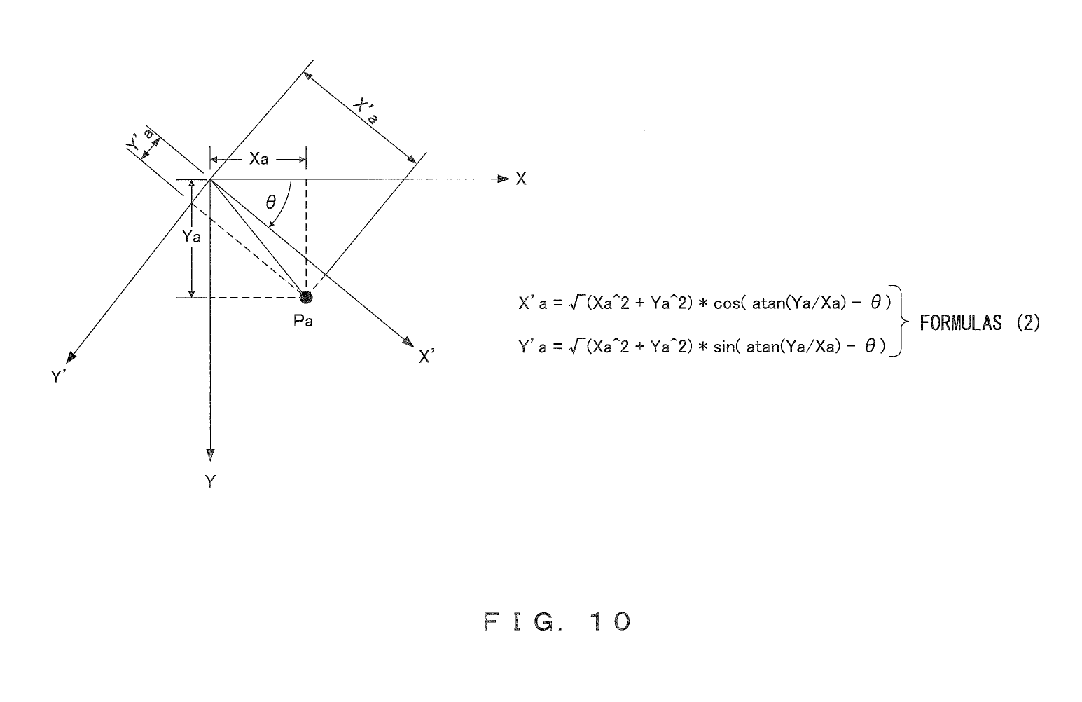

FIG. 10 is a diagram illustrating an example of corrections.

Assume that, as shown in FIG. 10, θ indicates the rotation angle, Xa indicates the X coordinate of the movement destination on a live image, and Ya indicates the Y coordinate of the movement destination on the live image. In this case, X′a, which is the X coordinate of the movement destination after conversion, and Y′a, which is the Y coordinate of the movement destination after the conversion, are expressed using the following formulas (2).

X′a=(Xa²+Ya²)^{1/2}×cos(a tan(Ya/Xa)−θ),

Y′a=(Xa²+Ya²)^{1/2}×sin(a tan(Ya/Xa)−θ) (2)

Therefore, when an instruction is given to perform a movement to spot Xa, Ya on a live image, a live image of the spot indicated on the live image can be displayed by moving the XY stage unit 103 to spot X′a, Y′ a calculated via the conversion for which the formulas (2) above are used

As an example, when θ=30°, Xa=1, and Ya=3^{1/2}, conversion is performed as follows:

X′a=2×cos(a tan(3^{1/2/b 1})−30°)=2×cos(30°)=2×3^{1/2}/2=3^{1/2}

Y′a=2×sin(a tan(3^{1/2}/1)−30°)=2×sin(30°)=2×½=1

As described above, according to the third embodiment, even in a structure in which, when an image is rotated, the XY axis direction on the screen is not identical with the XY axis direction of the XY stage, when an instruction is given to move the XY stage 103 while a live image is being rotated, the live image can also be moved to a targeted spot as in the case of the situation in which the live image is not rotated.

### Fourth Embodiment

Next, a fourth embodiment to which the present invention is applied will be described.

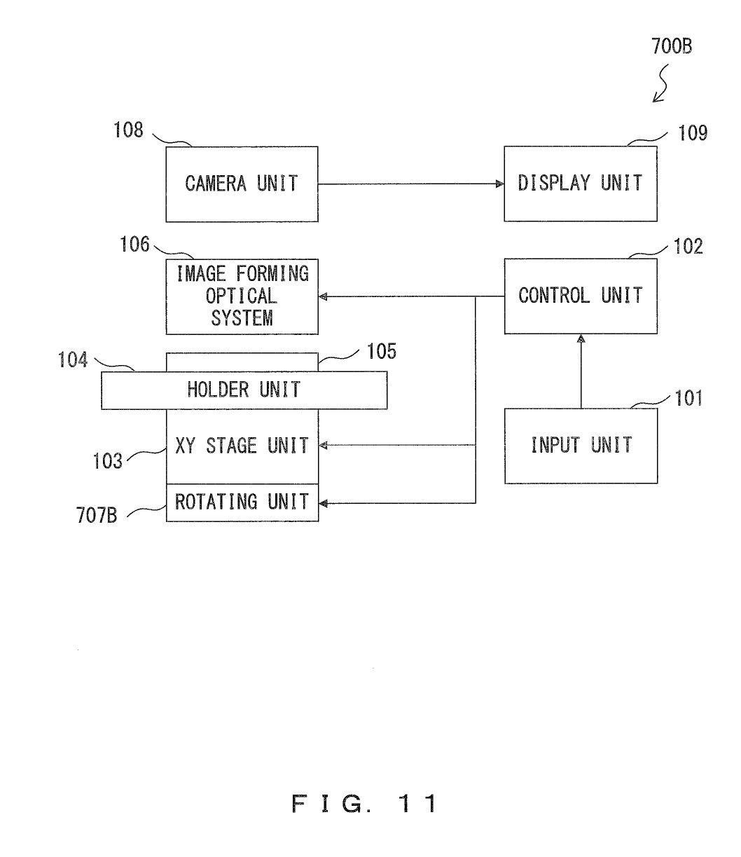

FIG. 11 is a diagram showing functions of a microscope according to the fourth embodiment.

In FIG. 11, a microscope 700B comprises a rotating unit 707B instead of the rotating unit 707A that was described using FIG. 8. In comparison with the rotating unit 707A that rotates the camera unit 108, the rotating unit 707B rotates the XY stage unit 103.

As a result of this configuration, the sample 105 can be moved while maintaining the position relationship between the rotation center and the center of the visual field.

### Fifth Embodiment

Next, a fifth embodiment to which the present invention is applied will be described.

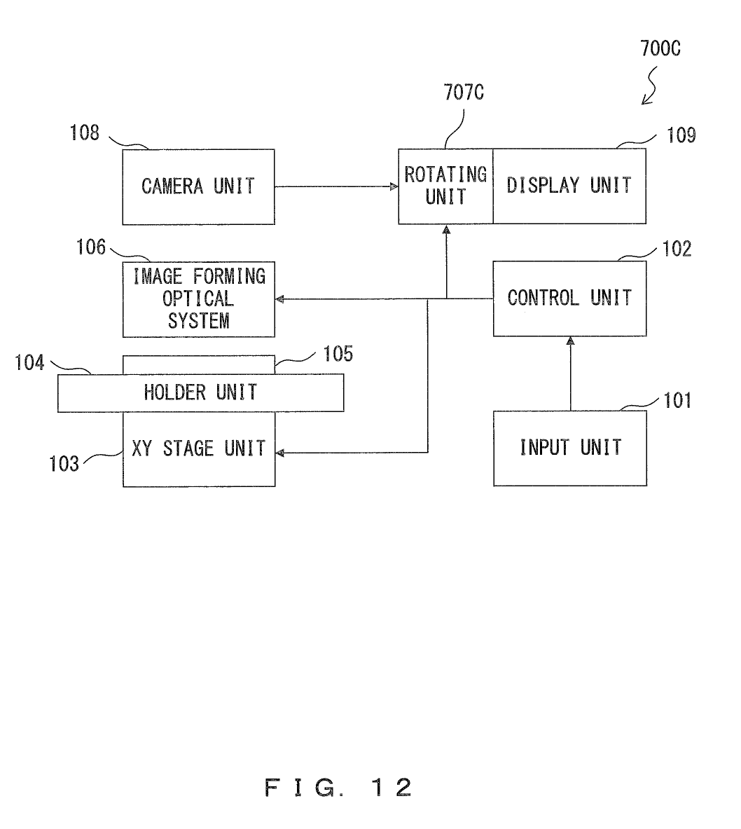

FIG. 12 is a diagram showing functions of a microscope according to the fifth embodiment.

In FIG. 12, a microscope 700C comprises a rotating unit 707C instead of the rotating unit 707A that was described using FIG. 8. In comparison with the rotating unit 707A that rotates the camera unit 108, the rotating unit 707B rotates the display unit 109.

As a result of this configuration, it is possible to apply a rotation process to an image shot by the camera unit 108 and to display it on the display unit 108.

### Sixth Embodiment

Next, a sixth embodiment to which the present invention is applied will be described.

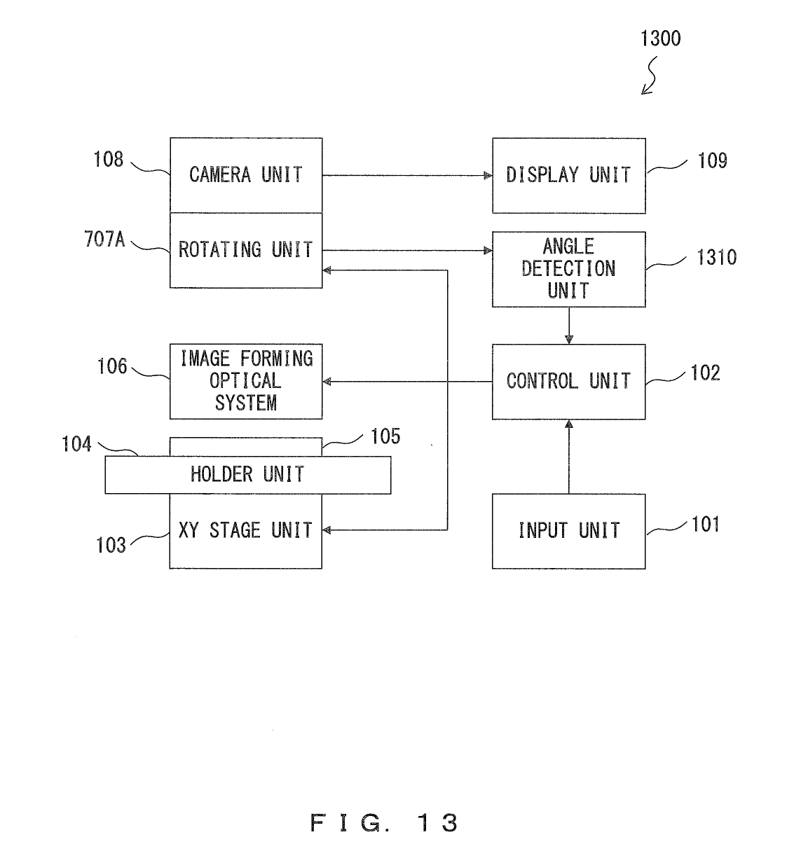

FIG. 13 is a diagram showing functions of a microscope according to the sixth embodiment.

In FIG. 13, a microscope 1300 comprises an angle detection unit 810 in addition to the components comprised by the microscope 100 according to the third embodiment that was described using FIG. 8.

In the third embodiment described above, a rotation angle, designated via an operator operating the rotation instruction unit 203, is input by the input unit 101. In the sixth embodiment, when the rotating unit 707A gives an instruction to rotate the camera unit 108 via a mechanical operation manually provided by an operator or via an electronic operation, an angle detection unit 1310 can also detect the rotation angle.

As an example, in FIG. 13, the angle detection unit 1310 connected to the rotating unit 707A can detect an angle using hardware, such as a rotary encoder, and can also detect an angle by calculating the movement direction from the image before the movement of the XY stage unit 103 and the image after the movement of the XY stage 103. As a result of this, when the operator gives an instruction, via a manual operation, to rotate the holder unit 104 via the rotating unit 107, the rotation angle (rotation amount) can also be grasped immediately.

### Seventh Embodiment

Next, a seventh embodiment to which the present invention is applied will be described.

In regard to the designation of a rotation angle in the first embodiment that was described using FIG. 4 and in the third embodiment, rotation can be designated using a method in which an operator directly inputs a value or a method in which a step movement is performed at fixed quantity intervals. However, since it is difficult to image the actual rotation result in accordance with the value, such a GUI cannot be absolutely considered as being a GUI that is easy for operators to use. Accordingly, a GUI as follows may be used.

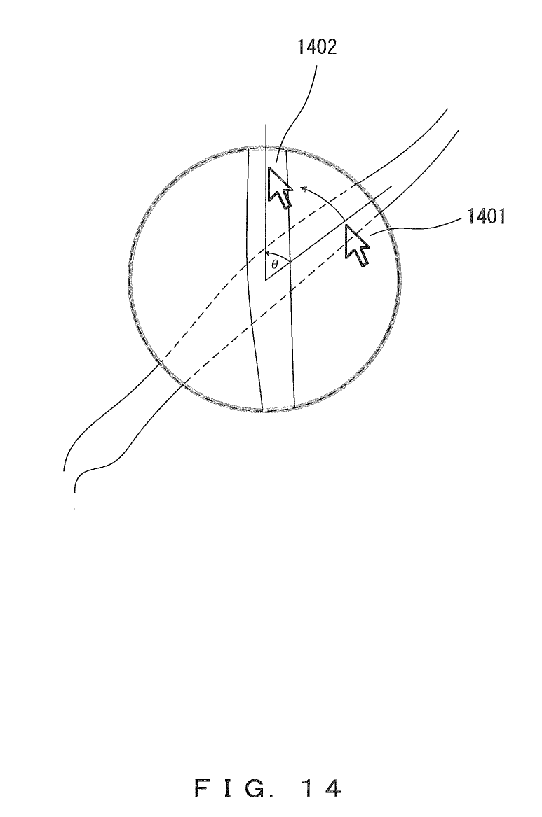

FIG. 14 is a diagram indicating a method for setting a rotation angle via a drag-and-drop operation on a live image.

The example indicated by FIG. 14 is an example in which a drag operation is performed using a computer mouse.

When the operator clicks and holds a spot 1401 and drags it in the direction of an arrow using a mouse, the sample image rotates around the center of the live image in accordance with this user's operation. The operator rotates the live image while looking at the screen, and performs a drop operation when the live image is rotated by a desirable angle. As a result of this, the control unit 102 calculates the value of rotation angle θ in accordance with the drag operation via the computer mouse, i.e., the control unit 102 calculates the value from the difference between the angle before the start of the drag operation and the angle of a drop spot 1402. Then, a rotation process, such as the one described above, is performed on the basis of the calculated value. As described above, the control unit 102 also serves as a rotation angle calculation unit.

The example indicated in FIG. 14 is an example in which only the image of the inside of a circle having its center at the center point of the live image is rotated. The portion to be rotated during a drag operation may be the entirety of an image, or may be only a portion of the image as in the case of the example of FIG. 14, in order to improve the processing speed.

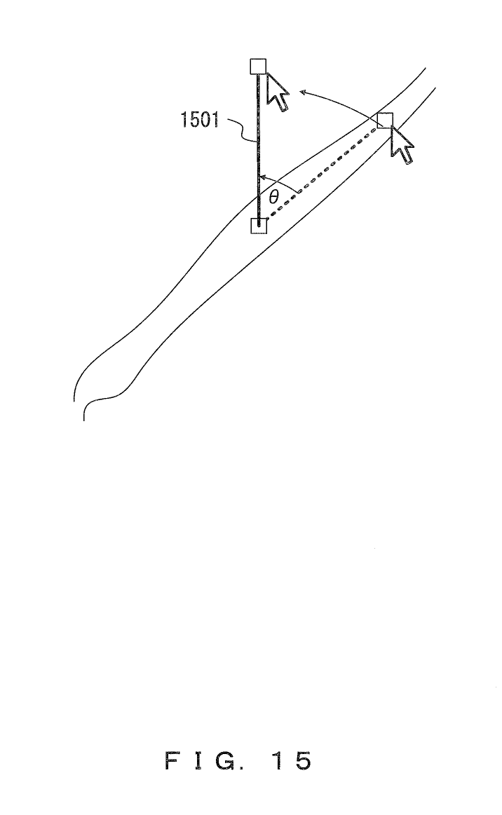

FIG. 15 is a diagram indicating a method for setting a rotation angle via a drag-and-drop operation for which a linear mark serving as an indicator is used.

As shown in FIG. 15, it is also possible to draw on the screen a linear mark 1501 having its starting point at the center of the live image and to rotate the image by dragging the linear mark 1501 instead of dragging the image. According to the method indicated by FIG. 15, the rotation angle can be set intuitively irrespective of the live image.

The first to seventh embodiments to which the present invention is applied have been described; however, the present invention is not limited to the first to seventh embodiments described above and the like, and various configurations or forms can be used without departing from the spirit of the present invention.

The present invention achieves the advantage that even in a structure in which the rotation center of a sample is not identical with the center of the visual field of observation, it is possible to provide a microscope having an image shooting function and having an image rotation function that does not decrease usability.

In addition, the present invention achieves the advantage that even in a structure in which when an image is rotated, the XY axis direction on the screen is not identical with the XY axis direction of the XY stage, and it is possible to provide a microscope having an image shooting function and having an image rotation function that does not decrease usability.

What is claimed is:

1. A microscope comprising:
a sample holding unit for holding a sample;
an image forming optical system for forming an image of the sample via an objective lens and an image forming lens;
an XY stage unit for moving the sample holding unit in an optional XY direction within an XY plane orthogonal to an optical axis of the image forming optical system;
a photographing device for photographing a sample image formed by the image forming optical system;
a display unit for displaying the sample image photographed by the photographing device;
a rotating unit for rotating the sample holding unit around an axis perpendicular to the XY plane; and
a control unit for controlling the XY stage unit and the rotating unit so that the sample image displayed on the display unit is rotated within a screen.

2. The microscope according to claim 1, further comprising
a rotation angle input unit for inputting a rotation angle by which the sample image rotates within the screen, wherein
the control unit calculates a movement amount of the sample holding unit to be moved by the XY stage unit on the basis of the rotation angle input by the rotation angle input unit and a relative position relationship between a current position of the XY stage unit that corresponds to a center of the display unit and a rotation center position that corresponds to a center of the rotating unit, and moves the XY stage unit in accordance with the calculated movement amount.

3. The microscope according to claim 2, wherein
the rotation angle input unit inputs, as a rotation angle, angle data designated by an operator.

4. The microscope according to claim 2, further comprising
a rotation angle detection unit for detecting a rotation angle by which the sample holding unit is rotated by the rotating unit, wherein
the rotation angle input unit inputs the rotation angle detected by the rotation angle detection unit.

5. The microscope according to claim 2, further comprising
a display image rotation angle calculation unit for calculating a rotation angle of a display image displayed on the display unit, wherein
the rotation angle input unit inputs the rotation angle calculated by the display image rotation angle calculation unit.

6. The microscope according to claim 5, wherein
in accordance with a drag operation of a computer mouse, the display image rotation angle calculation unit calculates a rotation angle of an image that rotates around the center of the display unit.

7. The microscope according to claim 5, wherein
in accordance with a drag operation of a computer mouse performed for a linear mark that is displayed to have a starting point at a center of the display screen, the display image rotation angle calculation unit calculates a rotation angle of a rotation of the linear mark around the starting point.

8. A microscope comprising:
a sample holding unit for holding a sample;
an image forming optical system for forming an image of the sample via an objective lens and an image forming lens;
an XY stage unit for moving the sample holding unit in an optional XY direction within an XY plane orthogonal to an optical axis of the image forming optical system;
a photographing device for photographing a sample image formed by the image forming optical system;
a display unit for displaying the sample image photographed by the photographing device;
a rotating unit for rotating the XY stage unit or the photographing device around the optical axis or for rotating the display unit around an axis orthogonal to a screen of the display unit; and
a control unit for controlling the XY stage unit and the rotating unit so that the sample image displayed on the display unit rotates within the screen.

9. The microscope according to claim 8, further comprising
a rotation angle input unit for inputting a rotation angle by which the sample image rotates within the screen, wherein
the control unit calculates a movement direction of the sample holding unit to be moved by the XY stage unit on the basis of the rotation angle input by the rotation angle input unit, and moves the XY stage unit in accordance with the calculated movement direction.

10. The microscope according to claim 9, wherein
the rotation angle input unit inputs, as a rotation angle, angle data designated by an operator.

11. The microscope according to claim 9, further comprising
a rotation angle detection unit for detecting a rotation angle by which the XY stage unit, the photographing device, or the display unit is rotated by the rotating unit, wherein
the rotation angle input unit inputs the rotation angle detected by the rotation angle detection unit.

12. The microscope according to claim 9, further comprising
a display image rotation angle calculation unit for calculating a rotation angle of a display image displayed on the display unit, wherein
the rotation angle input unit inputs the rotation angle calculated by the display image rotation angle calculation unit.

13. The microscope according to claim 12, wherein
in accordance with a drag operation of a computer mouse, the display image rotation angle calculation unit calculates a rotation angle of an image that rotates around a center of the display unit.

14. The microscope according to claim 12, wherein
in accordance with a drag operation of a computer mouse performed for a linear mark that is displayed to have a starting point at a center of the display screen, the display image rotation angle calculation unit calculates a rotation angle of a rotation of the linear mark around the starting point.
